(19) United States
(12) Patent Application Publication
(10) Pub. No.: US 2005/0258668 A1
(43) Pub. Date: Nov. 24, 2005

(54) AUTOMOTIVE HEADLINER HAVING IMPACT COUNTERMEASURES AND METHOD FOR MAKING THE SAME

(76) Inventor: Bari W Brown, Ann Arbor, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/709,658

(22) Filed: May 20, 2004

(51) Int. Cl. B60R 13/02

(52) U.S. Cl. 296/214

(57) ABSTRACT

An automotive headliner including a headliner support having upper and lower surfaces and a pair of opposite side edges with foam impact countermeasures integrally molded to the upper surface. The countermeasures form a pair of rails positioned adjacent the side edges and are adapted to absorb an impact from a vehicle occupant. A method of making the headliner includes inserting the headliner into a mold having first and second mold plates and corresponding first and second molding surfaces so that the lower surface faces the first molding surface. A release film is inserted into the mold between the upper surface and the second molding surface. The mold is closed and foam is injected into the mold between the upper surface and the release film. The mold is then opened and the headliner removed. The headliner may be removed prior to the foam being substantially completely cured.

### FIELD OF THE INVENTION

The present invention pertains generally to automotive headliners and more particularly to countermeasure structures used to reduce the force of impact on a vehicle occupant.

### BACKGROUND OF THE INVENTION

It is known to provide automotive interiors with various active and passive occupant protection systems. An example of an active occupant protection system is the well-known inflatable air bag that is deployed upon impact. The air bag, however, does not completely protect the occupant as there are other areas of contact including the roof structure, door structures and interior consoles. Automotive interiors often provide passive protection systems in these areas. For example, it is known to provide resilient foam padding to protect vehicle occupants from contact with the underside of the roof of the vehicle during impact. Indeed, such protection measures are the subject of regulations and associated legislation so far as vehicle manufactures are concerned. In particular, the U.S. Federal Motor Vehicle Safety Standard 201 defines particular impact characteristics and requirements for automotive interiors.

An automotive headliner lines the underside region of the driver and passenger compartment roof which is in proximity to the heads of persons traveling in the vehicle. Automotive headliners are required to fulfill several functions. They need to present an aesthetically pleasing surface finish to the vehicle roof inside surface. They also need to provide a convenient means of routing and attaching components in the vehicle interior. They further need to provide a degree of acoustical damping in order to reduce the noise in the vehicle.

Headliners are also now required to provide some level of energy management, arising from a requirement to absorb energy upon impact by a vehicle occupant's head. The requirements for energy management of an automotive interior as a whole are specified in Federal Motor Vehicle Safety Standard 201. This standard sets a maximum Head Injury Criterion (HIC) value for the interior as a whole.

Headliners may be constructed in a variety of ways and typically include a headliner support made of such materials as fibreglass, PET, urethane thermoset and the like. The headliner support provides the backing for additional layers such as scrim layers and cover stock material such as cloth, leather and the like. When a headliner is installed in a vehicle, the cover stock faces the vehicle interior. The side of the cover stock facing the vehicle interior is known as the A-surface. The interface between the cover stock and the substrate is known as the B-surface. The side of the substrate facing the vehicle roof is known as the C-surface.

The conventional approach to incorporate energy management foam into currently designed headliners is to attach individual foam pads to selective locations on the C-surface of the headliner. The foam pads are typically made and packaged in one location and shipped to the manufacturer of the headliners. The foam pads are then manually attached to the C-surface of the headliner using, for example, hand-held dispensing guns dispensing a hot melt adhesive. The foam pads are generally produced in a closed-mold process that requires three to four minutes of curing time within the mold before being removed and packaged. This conventional approach is labor intensive and time consuming, which translates into higher manufacturing costs for headliners.

Attempts have also been made to mold a headliner assembly having a headliner substrate and impact counter measure integrally molded in a single process step. This often necessitates the use of a single foaming material that accommodates the structural requirements of the headliner substrate while also accommodating the impact characteristics of the countermeasures. In some cases, the foaming material for the headliner substrate will be augmented with additional materials, such as glass fibers, to enhance the structural integrity of the headliner substrate. Nevertheless, using a single foaming material to satisfy the both aspects of the headliner assembly, i.e., the structural support of the substrate and the energy absorption of the countermeasures, often results in poor acoustic properties that make performance in various tests, such as the Noise, Vibration, Harshness (NVH) tests, routinely performed for automotive interiors, problematic. Moreover, when molding the headliner substrate and the countermeasures in a one step process, it can be difficult to evenly distribute the foaming material throughout the mold. This can lead to density variations in the molded assembly, which in turn adversely affects energy absorption and the overall effectiveness of the countermeasure.

There is a need for an improved headliner and a method for incorporating foam-based countermeasures that reduce the labor and overall manufacturing costs.

### SUMMARY OF INVENTION

The present invention provides an automotive headliner that incorporates a foam countermeasure, but which can be produced in an efficient and cost-effective manner. In one embodiment, the headliner comprises a headliner substrate having a lower surface adapted to face an automotive interior, an upper surface opposite to the lower surface adapted to face the underside of a roof and a pair of opposite side edges. A foam countermeasure is integrally molded onto at least a portion of the upper surface of the headliner support and adapted to absorb an impact force from a vehicle occupant during, for example, a collision. The countermeasure may include a pair of spaced apart rails positioned adjacent the side edges of the headliner support.

A closed mold process may be used to make the headliner. The headliner support is inserted into a mold having a first and second mold plate with corresponding first and second molding surfaces. The headliner support is inserted into the mold so that the lower surface confronts the first molding surface. The headliner support may be secured to the first molding surface by pulling a vacuum. A release film is inserted into the mold between the upper surface of the headliner support and the second molding surface. The release film generally lines the second molding surface and may be secured to that surface by pulling a vacuum. The mold is closed and foam is injected into the mold between the upper surface of the headliner support and the release film through a channel, and preferably a pair of channels, formed in the second mold plate and open to the second molding surface. The channels extend from cavities in the second molding surface to side edges of the second mold plate. The mold is then opened and the headliner removed from the mold. The headliner may advantageously be removed from the mold prior to the foam being substantially completely cured. The release film may then be removed from the headliner after the foam has substantially completely cured.

The features and objectives of the present invention will become more readily apparent from the following Detailed Description taken in conjunction with the accompanying drawings.

### BRIEF DESCRIPTION OF DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary automotive headliner according to the present invention;

FIG. 2 is a top plan view of an exemplary mold plate used to make the headliner of FIG. 1;

FIG. 3 is a cross-sectional view of a mold for making the headliner of FIG. 1 generally taken along line 3-3 of the mold plate in FIG. 2; and

FIG. 4 is a cross-sectional view of the mold of FIG. 3 being closed and having foam injected into the mold.

### DETAILED DESCRIPTION

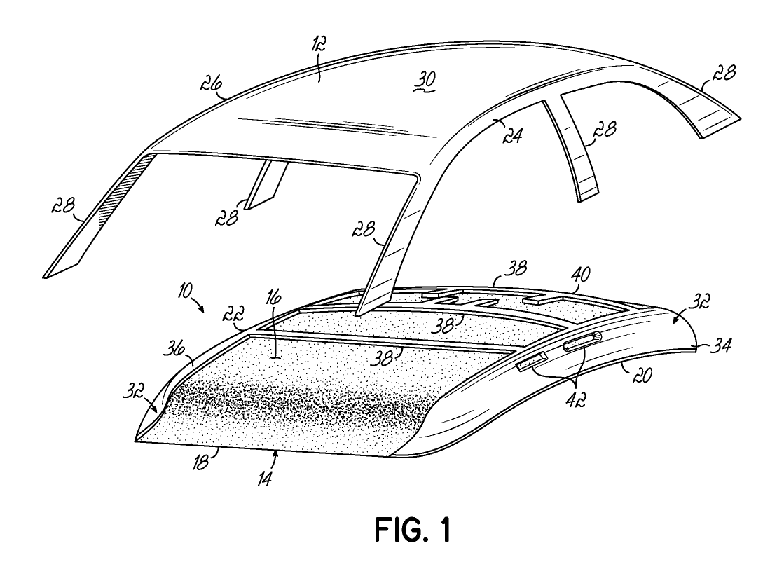

Referring to FIG. 1, there is shown an exemplary automotive headliner, generally indicated at 10, constructed in accordance with the present invention. The headliner 10 is adapted for use in a motor vehicle including a roof 12. The headliner 10 includes a rigid, self-supporting headliner support, generally indicated at 14, which is adapted to be mounted adjacent the interior of roof 12 so as to underlie the roof 12 and shield the roof 12 from view. As is known by those having ordinary skill in the art, the headliner support 14 may include a substrate made of fiberglass, PET, urethane and the like, scrim layers and cover stock, such as cloth, leather and other decorative fabrics. The headliner support 14 has an upper surface 16, lower surface 18 opposite upper surface 16 and a pair of opposite side edges 20, 22. The upper surface 16 is adapted to face the underside of the roof 12 and the lower surface 18 is adapted to face the interior of the vehicle. The lower surface 18 generally comprises the cover stock material to provide the aesthetic aspect of the headliner 10. The side edges 20, 22 of the headliner support 14 generally align with the side edges of the roof 24, 26, which are coupled to roof supports 28 for attaching the roof 12 to the automobile body (not shown). The roof supports 28 support the roof 12 along the periphery of the roof 12, including side edges 22, 24, making the roof 12 generally inflexible along the side edges 22, 24 but allowing some flexibility in the central region 30 of the roof 12.

The headliner 10 also includes a plurality of foam countermeasures, generally indicated at 32, integrally molded onto the upper surface 16 of the headliner support 14 and adapted to absorb an impact force from a vehicle occupant such as, for example, during a collision. The energy absorbed by the foam countermeasures 32 reduces the likelihood of serious injury to the occupant during a collision where the occupant contacts the roof 12 of the vehicle. In an exemplary embodiment, the foam countermeasures 32 include a pair of spaced apart foam rails 34, 36 positioned adjacent side edges 20, 22 of the headliner support 14 and extending generally parallel thereto. The rails 34, 36 are strategically positioned on the headliner support 14 so that when the headliner 10 is attached to the roof 12, the rails 34, 36 are located in areas where the roof 12 is supported (along side edges 24, 26) and thus less likely to absorb energy during an impact with a vehicle occupant. The addition of the foam countermeasures 32 to the supported regions of the roof 12 provides those regions with an energy-absorbing capacity they otherwise would not have.

The foam countermeasures 32 may further include one or more cross members 38 that connect the pair of rails 34, 36 such as along a front edge 40 of the headliner support 14 or along various headliner components, such as sunroofs, roof consoles and the like. Those having ordinary skill in the art will recognize that the foam countermeasures 32 may be configured to provide an energy-absorbing capacity to any region of the roof 12 and is thereby not limited to the specific configuration illustrated and described herein. As shown in FIG. 1, the foam countermeasures 32 may be configured so as to not disrupt other aspects of headliner 10, such as attaching various headliner components including sun visors, rearview mirrors, grab handles and the like. To this end, the foam countermeasures 32 may include apertures 42 that permit the various headliner components to be securely attached to the roof 12.

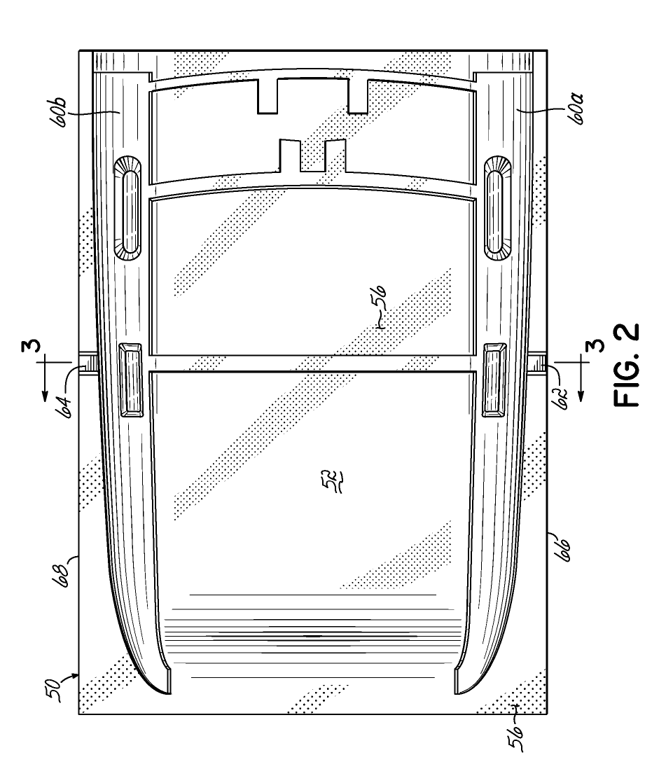

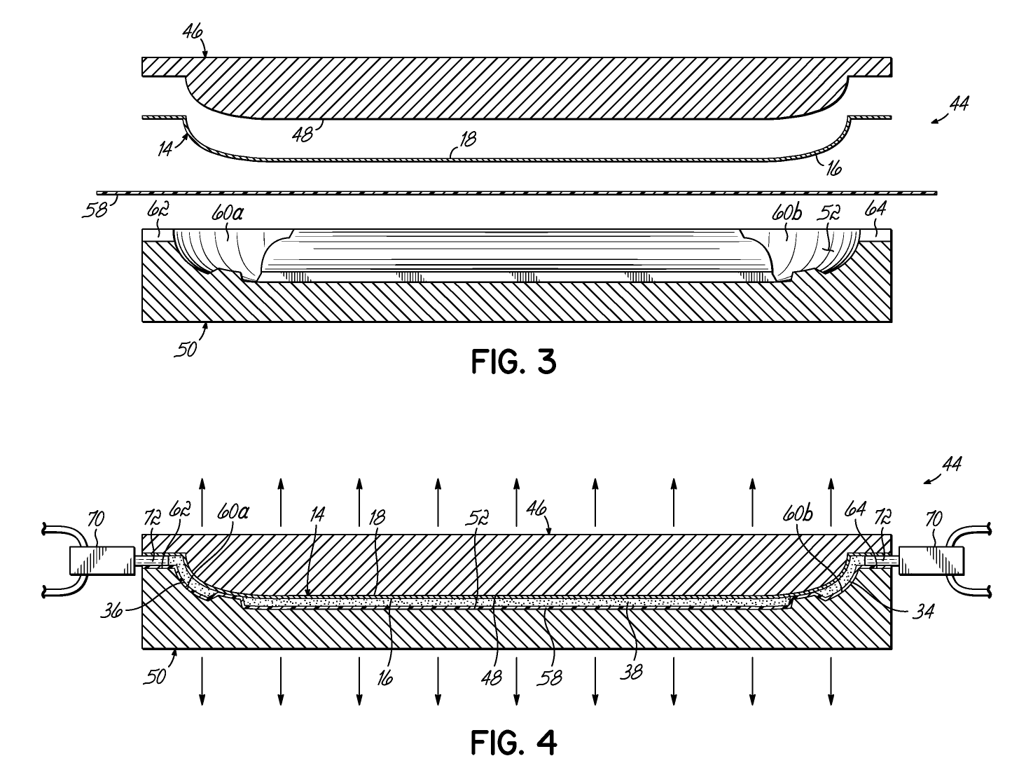

A method for integrally molding the foam countermeasures 32 directly on the upper surface 16 of the headliner support 14 is now described in detail. As shown in FIGS. 2-4, the process may be characterized as a closed mold process utilizing a mold, generally indicated at 44, including a first mold plate 46 having a first molding surface 48 and a second mold plate 50 having a second molding surface 52 confronting the first molding surface 48. First and second molding surfaces 48, 52 are generally configured to conform to the shape of the headliner support 14. The headliner support 14 is inserted in the mold 44 so that the lower surface 18 of headliner support 14 faces the first molding surface 48. As is known in the art, and as illustrated by the arrows in FIG. 4, the first mold plate 46 may include a plurality of vacuum lines terminating in vacuum ports that may, for example, cover a substantial portion of the first molding surface 48 and adapted to secure the headliner support 14 to the first mold plate 46 by pulling a vacuum on headliner support 14.

According to the invention, a release film 58 is inserted into mold 44 and positioned between the upper surface 16 of the headliner support 14 and the second molding surface 52. The release film 58 may be formed from polyethylene, polypropylene and other suitable materials and, as will be described below, prevents the foam from sticking to second molding surface 52 during the molding process. As best shown in FIG. 2, second mold plate 50 includes recesses or cavities in second molding surface 52 adapted to receive the foam for forming the countermeasures 32. For instance, cavities 60a and 60b correspond to the rails 34, 36 respectively. The release film 58 overlies and lines the second molding surface 52 so as to conform to the shape of the second molding surface 52. As shown in FIG. 2 and illustrated by the arrows in FIG. 4, the second mold plate 50 may include a plurality of vacuum lines terminating in vacuum ports 56 that may, for example, cover a substantial portion of the second molding surface 52. The release film 58 is adapted to be secured to the second mold plate 50 and conformed to the shape of the second molding surface 52 by pulling a vacuum on release film 58.

As shown in FIG. 4, after insertion of the headliner support 14 and the release film 58 into the mold 44, the mold 44 is closed and foam is injected into the mold 44 between the upper surface 16 of the headliner support 14 and the release film 58. To this end, the second mold plate 50 includes a channel, and preferably a pair of channels, 62, 64, extending from cavities 60a and 60b to the side edges 66, 68 of second mold plate 50. The channels 62, 64 are formed in second mold plate 50 so as to be open along second molding surface 52. The channels 62, 64 are advantageously placed along the side edges of second mold plate 50 to avoid forming a hole in the headliner support 14 or the release film 58 so as to inject the foam into mold 44. A pair of mixheads 70 having corresponding nozzles 72 are inserted into channels 62, 64 where liquid foam, such as that used in the well-known reaction injection-molding (RIM) process, is injected into cavities 60a and 60b of second mold plate 50. Mold 44 is then opened and headliner 10 is removed. In this way, the foam countermeasures 32 are formed directly on the upper surface 16 of the headliner support 14, as shown in FIG. 1.

In one advantageous aspect of the invention, the headliner 10 may be removed from mold 44 before the foam is substantially completely cured. In a conventional approach, such as that used to make individual foam pads, the molding surface is sprayed with a wax or other suitable material to prevent the foam from sticking to the mold. If the foam pad is removed from the mold before being substantially completely cured, the foam pad will not generally retain its desired shape or may have a portion of the foam pad stick to the molding surface. Thus in the conventional approach, the foam pad must be substantially completely cured before being removed from the mold. This may generally take on the order of three to four minutes.

In the present invention, however, a release film 58 is used to line the second molding surface 52. Thus when the headliner 10 is removed from the mold 44 prior to the foam being substantially completely cured, the foam retains its desired shape and does not stick to the second molding surface 52, as the release film 58 is removed with the headliner 10. Thus in the present invention, the curing process may be completed outside mold 44 and, instead of being in the mold 44 for approximately three to four minutes, the headliner 10 may be removed from mold 44 in approximately 90 seconds. The release film 58 may be removed from the headliner 10 after the headliner is removed from mold 44 and the foam has substantially completely cured.

The invention, as herein described, provides a number of advantages. First, because the invention utilizes a release film 58, the headliner 10 may be removed from the mold 44 prior to complete curing of the foam. This reduces the time to manufacture a headliner 10. Additionally, because the foam countermeasures 32 are integrally molded directly onto the headliner support 14, the time and costs of making, packaging and shipping foam pads to a separate manufacturing location has been reduced or eliminated. Furthermore, the time, labor and costs associated with manually attaching the foam pads to the upper surface of the headliner support 14 with hot melt adhesives has been eliminated.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. An automotive headliner adapted to line the interior of a roof, comprising:
a headliner support having a lower surface adapted to face an automotive interior and an upper surface opposite to said lower surface and adapted to face the roof, said headliner support having a pair of opposite side edges; and
a foam countermeasure integrally molded onto at least a portion of said upper surface of said headliner support and adapted to absorb an impact force from a vehicle occupant, said countermeasure including a pair of rails positioned adjacent said side edges.

2. The automotive headliner of claim 1, wherein said countermeasure further comprises:
a cross member connecting said pair of rails.

3. The automotive headliner of claim 1, wherein said countermeasure includes at least one aperture adapted to receive a headliner component therethrough and attach to the roof.

4. A method of making an automotive headliner having a plurality of foam countermeasures, the headliner including a headliner support having a lower surface adapted to face an automotive interior and an upper surface adapted to face an interior of a roof, comprising:
inserting the headliner support into a mold having first and second mold plates with corresponding first and second molding surfaces, the lower surface of the headliner support confronting the first molding surface;
inserting a release film into the mold between the upper surface of the headliner support and the second molding surface;
closing the mold;
injecting foam into the mold between the second surface of the headliner support and the release film to form the foam countermeasures directly on the upper surface of the headliner support;
opening the mold; and
removing the headliner from the mold.

5. The method of claim 4 further comprising:
securing the headliner support to the first molding surface using vacuum pressure.

6. The method of claim 4 further comprising:
securing the release film to the second molding surface using vacuum pressure.

7. The method of claim 4, wherein injecting foam into the mold comprises:
injecting foam through a channel formed in the second mold plate and open to the second molding surface, the channel accessible along a first side edge of the second mold plate.

8. The method of claim 4, wherein injecting foam through a channel formed in the second mold plate comprises:
injecting foam through a pair of channels formed in the second mold plate and open to the second molding surface, one channel accessible along a first side edge of the second mold plate, the other channel accessible along a second side edge opposite to said first side edge.

9. The method of claim 4 further comprising:
removing the release film from the headliner after removing the headliner from the mold.

10. A method of making an automotive headliner having a plurality of foam countermeasures, the headliner including a headliner support having a lower surface adapted to face an automotive interior and an upper surface adapted to face an interior of a roof, comprising:
inserting the headliner support into a mold having first and second mold plates with corresponding first and second molding surfaces, the lower surface of the headliner support confronting the first mold surface;
closing the mold;
injecting foam into the mold between the upper surface of the headliner support and the second molding surface to form the foam countermeasure directly on the upper surface of the headliner support;
opening the mold; and
removing the headliner from the mold prior to the foam countermeasures being substantially completely cured.

11. The method of claim 10 further comprising:
lining the second molding surface with a release film prior to injecting the foam into the mold.

12. The method of claim 11 further comprising:
removing the release film from the headliner after the foam has substantially completely cured.
